(19) United States
(12) Patent Application Publication
(10) Pub. No.: US 2022/0310280 A1
(43) Pub. Date: Sep. 29, 2022

(54) Method And Arrangement Using Buried Tubular Members To Increase The Rate Of Decay Of Radioactive Contamination

(71) Applicant: Andrew Niemczyk, Hazel Park, MI (US)

(72) Inventor: Andrew Niemczyk, Hazel Park, MI (US)

(21) Appl. No.: 17/213,570

(22) Filed: Mar. 26, 2021

(51) Int. Cl. G21F 9/28; B09C 1/00

(52) U.S. Cl. CPC G21F 9/28; B09C 1/00; B09C 2101/00

(57) ABSTRACT

A method and combination for increasing the rate of radioisotope decontamination in a layer of soil beneath the ground surface, as well as in low growing plants on the ground surface, in which an array of elongated tubular members with defined lengthwise passageways, acting as a passive system, are inserted into vertical holes drilled into the ground. The elongated tubular members are slotted along their lengths to capture positrons emitted into the soil and direct the flow of the captured positrons into the soil layer

### BACKGROUND OF THE INVENTION

This invention seeks to greatly increase the rate of decay of radioisotopes contaminating soil, and in particular soil near the ground and in low lying vegetation just above the soil, to make this area safe for habitation. The current contamination, resulting from a nuclear power plant melt down, is deadly. This large area of previously habitable land is utterly unusable, and without treatment, this land will be unusable for centuries to come.

Radioisotopes, as studied in higher level physics, have a highly unstable nucleus. This nucleus will eventually reach homoeostasis and become stable. One of the most common ways this nucleus will become stable is by emitting a subatomic particle such as a positron. These emissions occur independently but not consistently in nature.

Radioactive contamination levels will decline naturally over time, albeit slowly, until the radiation levels become minimal. This is a natural life cycle. Unfortunately, the natural life cycle has been disrupted when assembly of large molecules that have a greater impact then what is found in nature began with human activity. There are several large areas of land severely contaminated with harmful radioisotopes by human activity all around the world. The most well-known was the complete melt down of a nuclear reactor at Chernobyl, Ukraine, in 1986 resulting in contamination of a large ground surface by plutonium and uranium isotopes. This has completely prevented use of this land at the site of the disaster. This new technology can reverse this negative impact on earth and its soil, with simply using the earth's natural energy and harnessing and redirecting this power to achieve this purpose.

At the present natural rate of decay, normal use of that contaminated land area will be prevented for many centuries to come. One technique that has been used to speed up reclamation of the land is to remove the contaminated soil down to a depth of three feet, and storing the removed soil in underground enclosures which often leak after a few years. This approach is thus impractical even for small areas.

It is generally known that subatomic particles such as positrons are rare. Positrons come from the decay of nuclides that have an excess of protons in their nucleus, such as radioactive nuclei. This type of decay creating positron emission is a subtype of radioactive decay referred to as beta decay. Positrons are continuously and naturally emitted in random directions from decaying radioisotopes disposed at substantial depths of the soil below the surface of the ground. Emitted positrons do not travel far unless in a vacuum or in a created space, because they will quickly encounter an electron, and when this happens the positron and electron annihilate each other destroying themselves instantaneously.

The present inventor has realized that if a positron contacts the nucleus of a radioisotope atom or an atom of a radioisotope molecule, that atom will immediately be caused to decay.

Thus, such emitted positrons could potentially be used to reduce radioisotope contamination by collecting and redirecting great numbers of these particles into the soil at a shallow depth on the same order as is usually contaminated, i.e., about three feet below ground as well as into vegetation on the surface. When this is continued over time, a much more rapid decay of contaminants occurs such that the land can be restored to normal use in just a few years and at a much lesser cost than currently known alternatives.

The purpose of the present invention is to effectively cause a much more rapid decay of radioisotope contamination in soil at or below ground level down to a depth on the order of three feet as well as in low growing plants just above the ground surface.

### SUMMARY OF THE INVENTION

The goal of the above recited invention is in fact an introduction of a novel technique to utilize the positrons existing force in nature and direct this naturally occurring force to radioactive isotopes in the soil. This is achieved by a process involving the use of an array of elongated tubular members of varying lengths but which are much longer than three feet, which are specially configured in a manner according to the present invention. The members are installed into a corresponding array of holes vertically drilled into the surface of the ground in a particular pattern in a region of ground to be restored, the tubular members act to collect emitted positrons from natural decay reactions which will result in the radioactive isotopes being decontaminated at a rate greatly increased over what would occur naturally so as to enable restoring the land to be fit for normal use within just a few years.

The elongated tubular members are extrusions of a durable plastic such as polyethylene, each member forms a cluster of five equally spaced rounded passageways arranged about a center thereof and extending the full length of the elongated member. Each passageway is slotted lengthwise along an outer wall defining each passageway to allow positrons emitted from decaying radioisotopes deeper in the ground than three feet to enter the interior of the passageways through the slots and be captured therein. The captured positrons will advance rapidly up the passageways to the top of the elongated tubular members as a result of being acted upon by an electromagnetic field created by the upwardly moving positively charged positrons as well as by the decay of plutonium and uranium radioisotopes which are the source of contamination of the soil to a depth of around three feet of the soil below the ground surface.

Each elongated tubular member is blocked at its top by a cap installed over the upper end of each member. The caps extend down along the upper end of the member for a short distance, i.e., seven inches, and also have lengthwise passageways formed in the exterior of the cap.

As noted, there are five passageways in the cluster equally spaced around the center of each member. This configuration has been determined to maximize the total number of positrons which are able to be captured by passing into one of the slots formed in the tubular elongated member. A narrower passageway is located at the center of the cluster disposed within the circle formed by the outer five passageways. The center passageway may also have an outer wall slot aligned with a slot of one of the outer passageways so that positron particles can enter into the center passageway from one of the outer passageways arranged around the center.

When the flow of positrons reach the inside end of the cap, they are constrained to reverse flow and are forced to pass down the length of the cap and thereafter out of the cap by encountering the flow of positrons coming up the passageways. The positrons also enter lengthwise slots defined on the exterior of the cap defining lengthwise flattened openings. The positrons ultimately diffuse up and pass out through the soil around the upper end of each elongated tubular member. This invention acts as a natural “particle accelerator” for lack of better words, creating space in the soil and collecting the positrons within the soil to circumvent this field into a narrow energy tube in the core of the elongated tubular member. This accumulation of energy is then accelerated and funneled towards the cap and released through the sides of the cap. With the force of the electromagnetic field created by the radioactive material, the positrons are attracted and directed towards unstable radioisotope nuclei and the collision break down the radioactive nuclei. The decay of the contamination is thereby greatly increased compared to the natural rate.

A relatively large number of elongated tubular members 10A-10F, made of a durable plastic such as polyethylene, and working as a passive system, are able to remain in contact with the soil for many years, are thereby arrayed within an area of the contaminated ground, i.e., 4849 members 10A-10F in a 100 meter square area (counting the boosters). A pattern of the elongated tubular members 10A-10F is formed by groupings of elongated tubular members of varying lengths and having upper ends disposed at varying distances below the surface of the ground to be decontaminated. The longer members have their upper ends correspondingly disposed further down from the ground surface and their lower ends further down into the ground. This allows a greater space for accommodating the greater number of positrons collected by the longer members.

As will be described below, the number of tubular members of each type generally increases as the length thereof decreases with the shortest length having by far the greatest numbers. This arrangement creates a substantially uniform distribution of positrons directed into the soil a short distance below the ground surface and also for a short distance above the ground surface to thereby reduce the number of contaminating radioisotope atoms in the soil and in the grasses and low growing weeds growing in the soil. A complete and substantially uniform treatment of the contaminated region is thereby obtained in as few as five years.

In addition to the elongated tubular members, a series of three much shorter elongated “booster” members are arranged around an upper end of a middle tubular member, the boosters are used to lower the energy of the unified magnetic field produced by the positrons upwardly flowing through elongated tubular members.

Two of the boosters in each set form a plane that extends at a right angle to the magnetic North pole. This slightly reduces the force of engagement of the positrons with the radioisotope nuclei. This has been found to increase the effectiveness of the contact of the positrons with the nuclei of the radioisotopes.

### DESCRIPTION OF THE DRAWINGS

FIG. 1 is a diagram representing each of the sets of six different lengths of elongated tubular members used to make up an array of a large number of elongated tubular members in an area within a contaminated area depicting the relative depths in the ground in which each configuration of the tubular members is installed, as well as the distance below the surface of the ground in which each configuration is buried.

FIG. 1A is an enlarged diagram of a middle elongated tubular member together with a set of three booster tubular members arranged around the upper end of the middle tubular member together with a simplified representation of an associated electromagnetic field.

FIG. 2 is a side view of an elongated tubular member main portion shown broken off in the middle thereof according to the invention.

FIG. 3 is an end view of the elongated tubular member main portion shown in FIG. 2 with certain dimensions indicated.

FIG. 3A is an enlarged end view of the elongated tubular member main portion shown in FIG. 3.

FIG. 4 is a front view of an upper fragmented portion of an elongated tubular member main portion having an end cap installed thereon.

FIG. 5 is a reduced size view of a section 5-5 taken in FIG. 6 of an elongated tubular member main portion and cap.

FIG. 6 is an enlarged end view of the elongated tubular member main portion and cap installed thereon.

FIG. 7 is a plan view of a pattern of a set of the longest length configuration 10A of the elongated tubular members shown in FIG. 1.

FIG. 8 is a plan view of a pattern of a set of 10B configurations of the elongated tubular members shown in FIG. 1.

FIG. 9 is a plan view of a pattern of a set of 10C configurations of the elongated tubular members shown in FIG. 1.

FIG. 10 is a plan view of a pattern of a set of 10D configurations of the elongated tubular members shown in FIG. 1 together with an associated set of booster tubular members.

FIG. 10A is an enlarged view of a partial pattern of a set of the 10D configurations of the elongated tubular members associated with three boosters 10G with the elongated tubular members.

FIG. 11 is a plan view of a pattern of a set of 10E configurations of the elongated tubular members shown in FIG. 1.

FIG. 12 is a plan view of a pattern of a set of 10F configurations of the elongated tubular members shown in FIG. 1.

FIG. 13 is a plan view of the complete array of elongated members of a 100 m square region using respective symbols to designate each configuration of the elongated members with the size of the symbols corresponding to the length of each elongated member in the array. That is, the larger the symbol the longer the corresponding elongated tubular members are.

FIG. 13A is an enlarged view of a portion of the complete array shown in FIG. 13.

FIG. 14 is an enlarged top view of the elongated tubular members 10D and 10G showing the orientation with respect to the magnetic North Pole.

FIG. 14A is an enlarged top view of the elongated tubular members 10D and 10G showing the orientation with respect to the magnetic North Pole and including the detailed elongated tubular member 10D.

FIG. 14B is an enlarged top view of the elongated tubular members 10D and 10G showing the orientation with respect to the magnetic North Pole at the time of installation as the system begins to acclimate and the direction the energy will flow from 10D to 10G indicated with arrows.

FIG. 14C is an enlarged top view of the elongated tubular members 10D and 10G showing the orientation with respect to the magnetic North Pole after a period of 2-3 months, when the system is partially acclimated, displaying the direction the energy will flow (as indicated by arrows) and the distribution of energy from 10D to 10G indicated with dotted lines between the arrows.

FIG. 14D is an enlarged top view of the elongated tubular members 10D and 10G showing the orientation with respect to the magnetic North Pole after a period of 5-6 months, when the system is fully acclimated, displaying the direction the energy flows (as indicated by arrows) and the distribution of energy from 10D to 10G indicated with dotted lines between the arrows.

FIG. 15 is a chart listing forth information on each configuration of the elongated tubular members and the depth at which they are positioned in the ground

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

According to the present invention this is done by collecting and concentrating a large number of emitted positrons present in the soil into a top layer of soil below the surface of the ground of a depth on the order of 3 feet of the soil at the ground surface as well as a short distance above the ground surface where plants are growing.

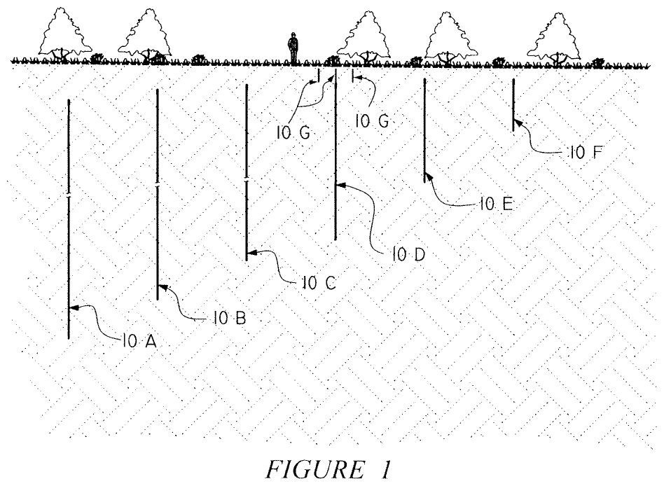

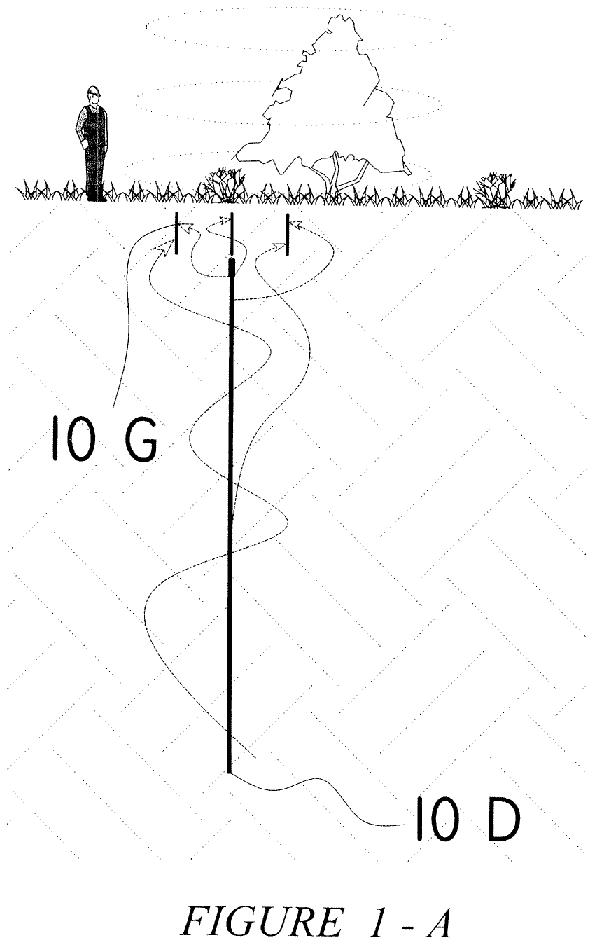

This is done by installing a large number of elongated tubular members 10 in vertically extending drilled holes. The elongated members are of varying configurations 10A, 10B, 10C, 10D, 10E and 10F as indicated in FIG. 1.

The elongated tubular members 10A-10F are identical in diameter and have the same internal features, but vary in length and are installed so that the upper ends thereof are at varying depths in the soil.

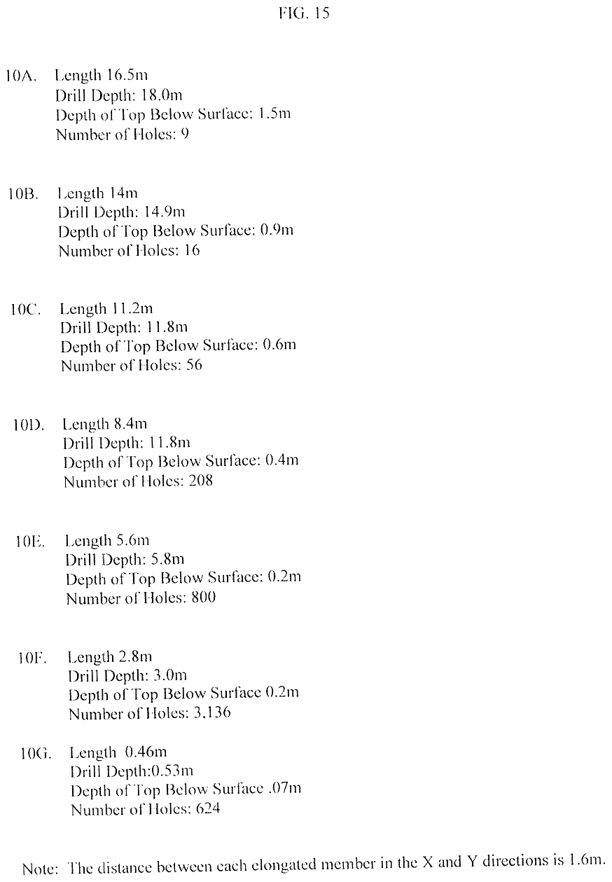

FIG. 15 is a chart listing information on each configuration, i.e., the length and number of the different elongated members and their position when installed in the drilled holes in the ground.

A plurality of each configuration of the elongated tubular members is installed so as to create a pattern in the ground region being treated as described below.

FIG. 1 is a diagram representing each of the sets of six different lengths of elongated tubular members used to make up an array of a large number of elongated tubular members in an area within a contaminated area depicting the relative depths in the ground in which each configuration of the tubular members is installed, as well as the distance below the surface of the ground in which each configuration is buried.

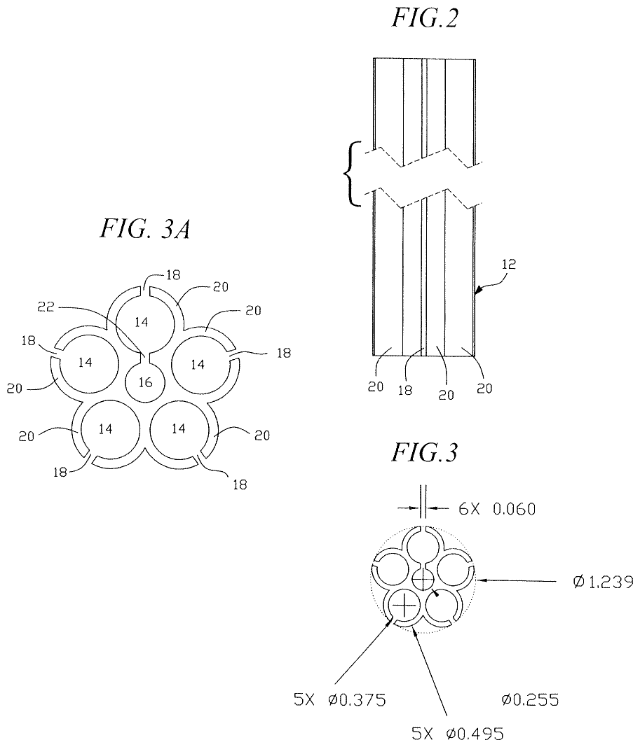

FIGS. 2, 3 and 3A show the internal details of a main portion 12 of the elongated tubular members 10A-10F, which as noted above are made of a suitable durable plastic material such as polyethylene.

All of the main portion members 12 and elongated tubular members 10 are straight and have uniform internal and external details for its entire length.

A cluster of five outer passages 14 are formed in each of the main portion members 12 which are each preferably circularly shaped and arranged around a center passage 16 thereof.

A radially extending slot 18 is formed in the outermost part of the walls 20 defining each of the outer passages 14.

A wall 14A defining the center passageway 16 also has a radially extending slot 22 aligned with one of the slots 18 in one of the outer passages.

FIG. 3A shows preferred dimensions of the features of the main portion of the elongated tubular member 12 as described above.

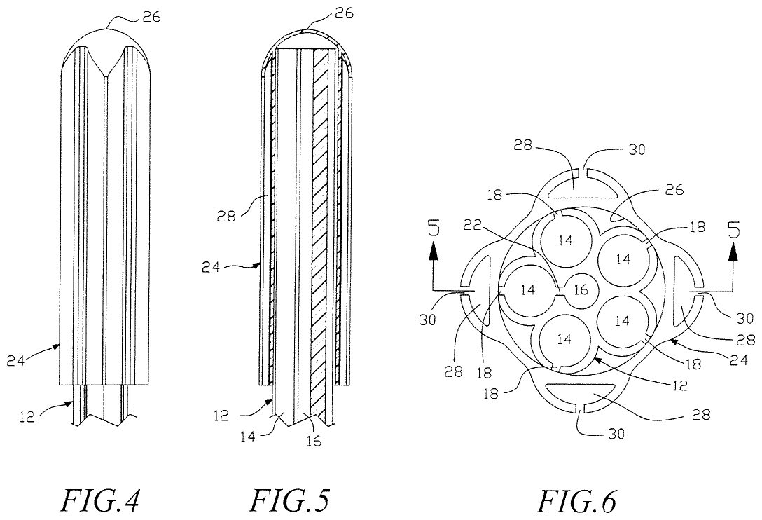

FIG. 4 is a side view of a cap 24 installed on the upper end of each main portion 12.

FIG. 5 is a cross section of a cap 24 installed on the upper end of each main portion 12.

FIG. 6 is an enlarged end view from the bottom of the main portion 12 with the cap 24 installed thereon to form an elongated member 10, and FIG. 5 is a view of the section 5-5 taken in FIG. 6.

The cap 24 has an upper end 26 which is molded into a radius which blocks all flow of the positrons particles out from the upper ends of both the elongated member main portion 12 and cap 24 as shown in FIG. 6.

As seen in FIG. 5, the cap 24 has a continuous circular internal wall 25 tightly engaging the outside diameter of the elongated member main portion 12 effectively blocking the slots 18 so that the flow of positrons particles is directed to the blocked end of the cap 24.

At that point, the flow of positrons is reversed and will thus meet the continuing incoming flow up the passages 14, 16 and spill out to the sides, a cloud of positrons thereby directed out and up towards the ground surface. The dense cloud of positrons causes contact with a great number of unstable nucleuses in the contaminating radioisotopes of plutonium and uranium.

This creates a substantially uniform treatment of the soil in the treated layer below the ground surface and vegetation just above the ground.

The cap 24 is itself formed with external passages 28 which have slots 30 in the walls forming the passages 28 which receive some of the positron flows which are directed up toward the ground surface joining in the cloud of positrons passing through the soil, causing the unstable nucleuses of the uranium and plutonium to react so as to stabilize the nucleuses of radioisotope atoms and molecules of the uranium and plutonium radioisotopes in the three foot ground layer of soil.

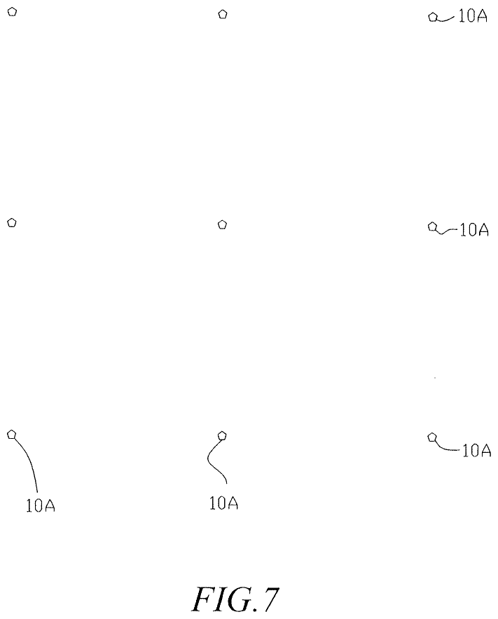

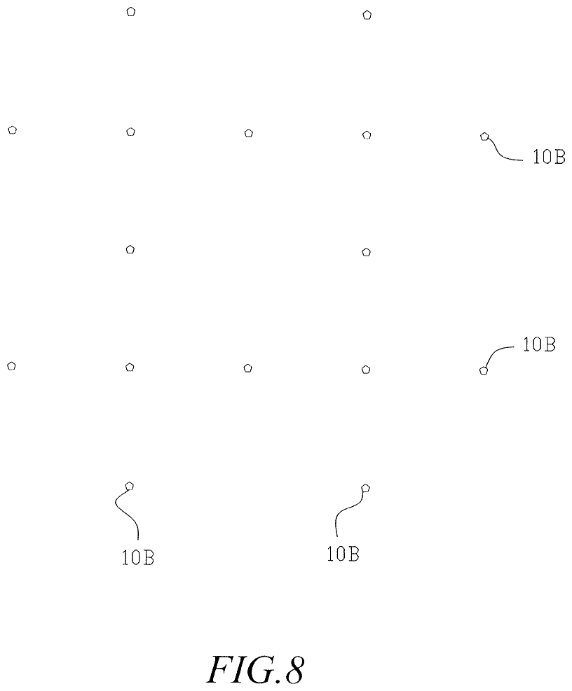

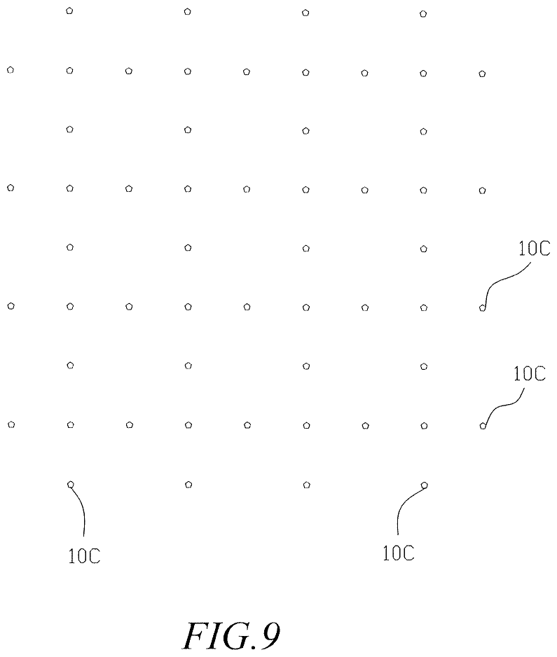

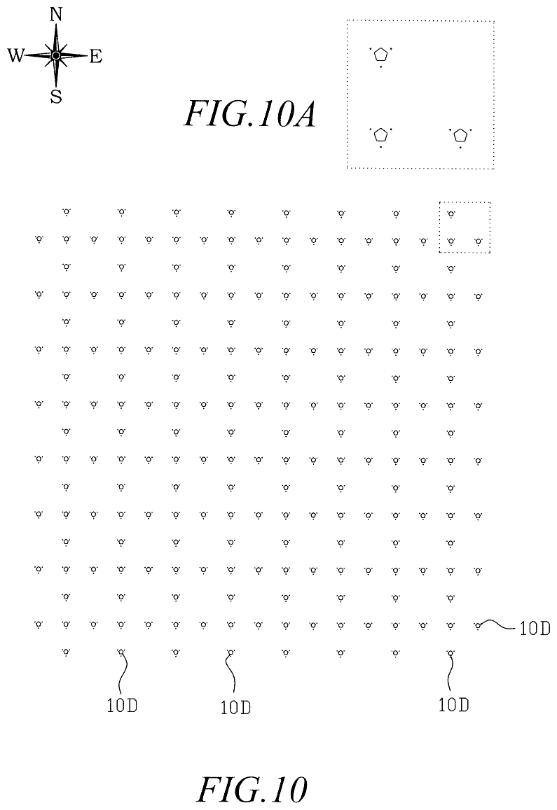

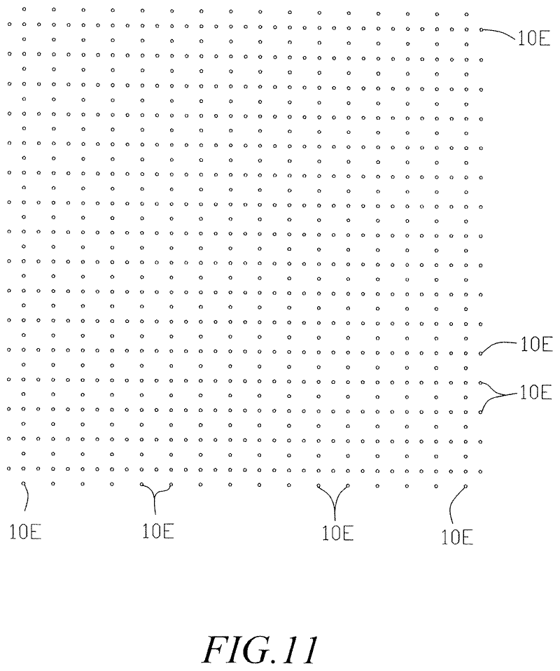

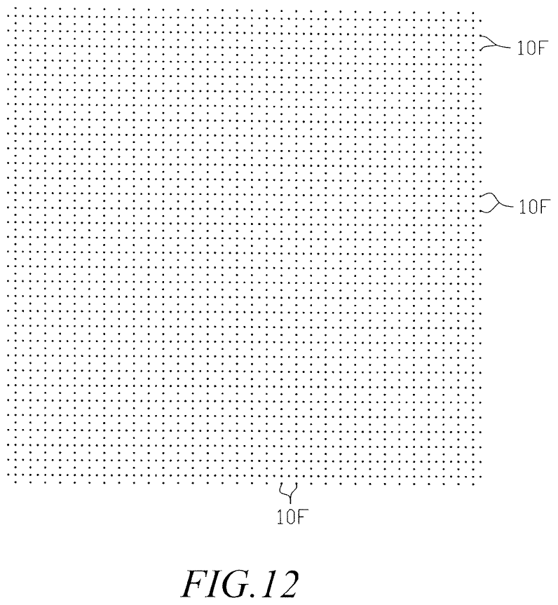

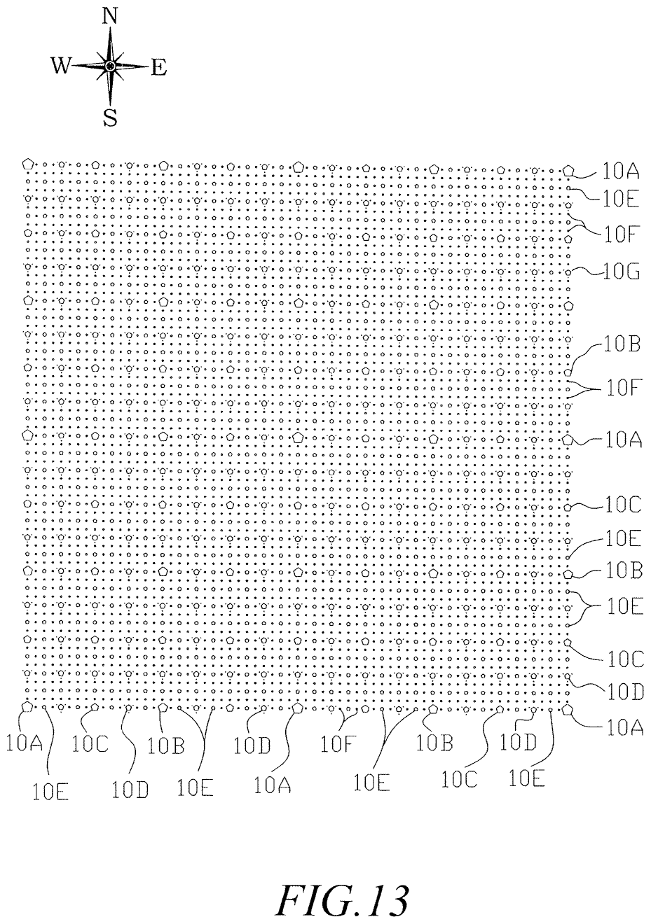

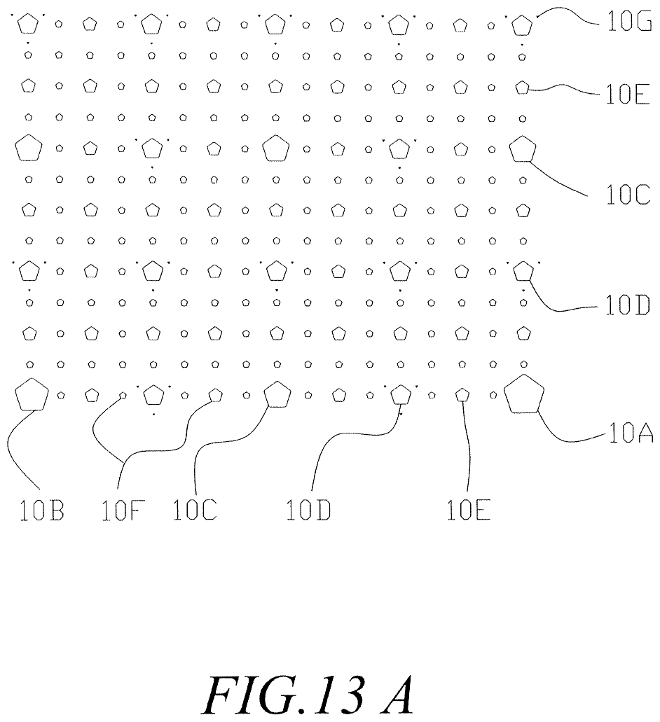

Each of the elongated members 10A-10F are arranged in the combined pattern shown in FIG. 13. The pattern of each of the elongated members 10A-10F is shown in FIGS. 7-12 respectively. As seen in these Figures, the longest of the elongated members (10A) is represented by the largest sized symbol, with decreasing sized symbols representing shorter length elongated members 10B-10F as labeled.

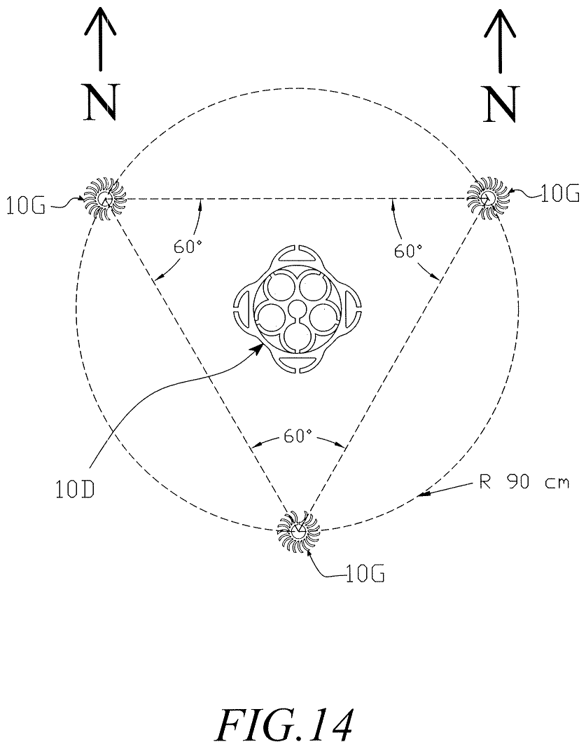

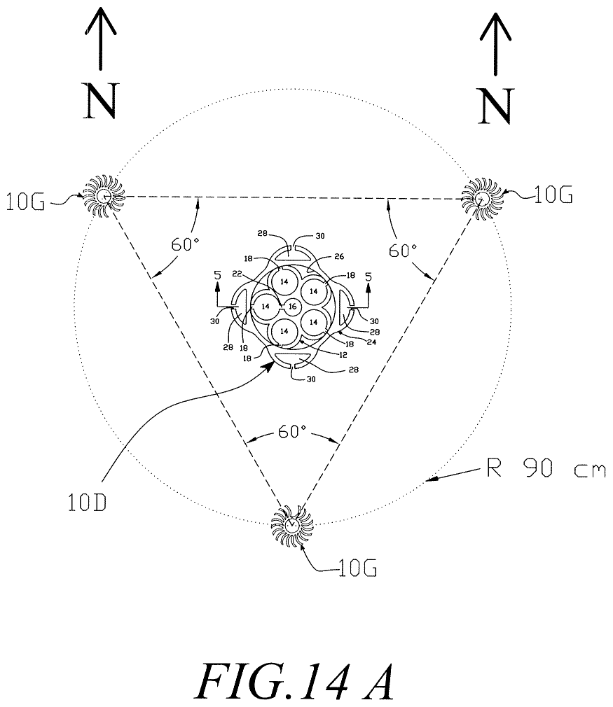

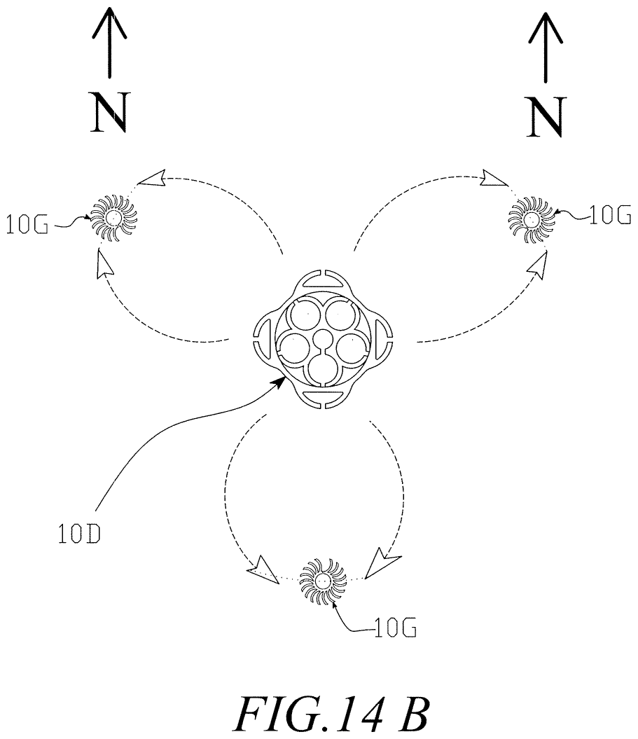

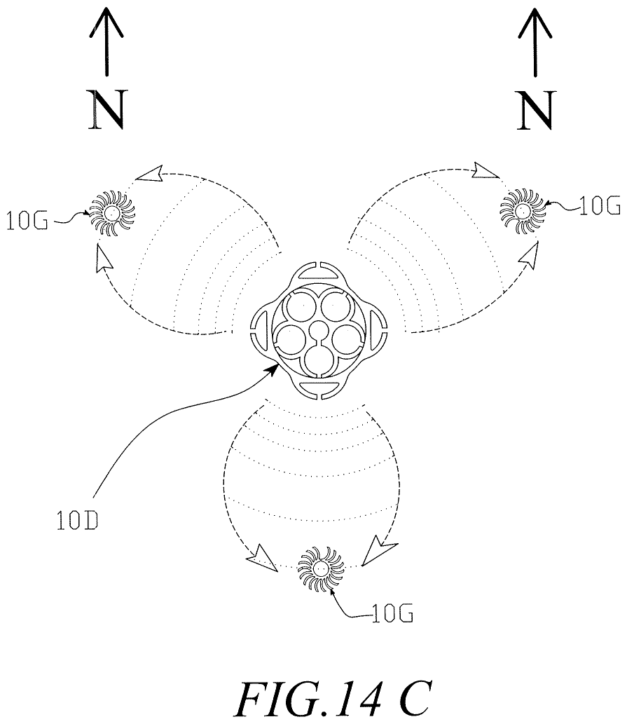

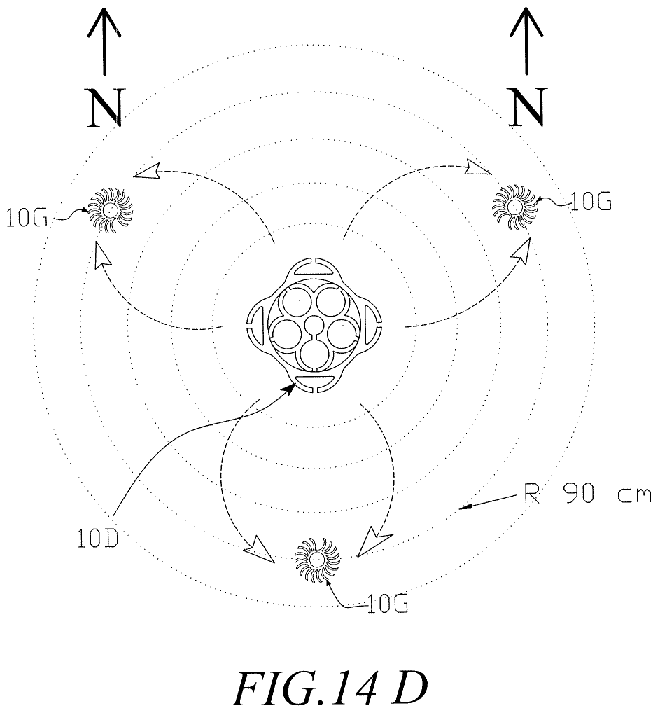

FIGS. 14, 14A, 14B, 14C, and 14D all show an enlarged top view of the elongated tubular members 10D and 10G showing the orientation with respect to the magnetic North Pole. FIG. 14A shows the detailed elongated tubular member 10D. FIGS. 14B, C, and D respectively show the time it takes the system to acclimate and the direction of the flow of energy from 10D to 10G.

It should be noted here that positrons when emitted do not travel far before encountering an electron if in air and go no further.

However, soil does not normally contain air which slowly rises out of the ground to completely leave the soil unless it has been disturbed as by plowing, etc. The drilling necessary to install the members 10A-10g allows air to be reintroduced into the soil. Therefore, the soil has to be backfilled at the surface of the ground above the elongated tubular members after installing the members 10A-10F to prevent air from entering any space which is open. The air will slowly rise up and out of the soil. The absence of air allows the positrons to travel substantial distances within the elongated tubular members after being emitted to stabilize a radioisotope. This takes about five months to occur, so no increase in decaying occurs for about five months after the installation is completed.

It should be understood that a common intensity electromagnetic field is associated with respect to the area above all of the elongated tubular members 10A-10F since exposed to each other.

It is also noted that the present invention includes the tubular booster members 32 which have a series of circumferentially curving blades developed by the present inventor as described in U.S. Pat. No. 10,736,252, incorporated herein by reference.

The function of the booster members 10G as applied here acts to loosen the ground but more importantly by being aligned with the North magnetic pole the energy of the collective electromagnetic field generated by the flow of the positrons is reduced slightly by the weakening of the combined electromagnetic field by the earth's magnetic field involves installing a series of three tubular booster members 10G formed with curving blades as shown in a series of drilled holes within the ground region to be treated for a contamination. In that technology applied to the present invention, three booster members are inserted in drilled holes spaced around the upper end of each of the elongated tubular members 10D. The booster members are 0.46 m (18 inches) long with the tops thereof at a depth of 0.07 m (3 inches) below the ground surface.

The shallow depth of booster members 10G allows easy removal for reuse after the ground region has been treated.

### Installation Process

Preparation

1. Walk the perimeter of the install zone marking the corners.

2. Once the perimeter of the zone has been laid out. trees, shrubs, and any other obstacles that will hinder drilling must be removed and disposed of in accordance with regulation.

3. Using the layout provided. the locations of the tubular members are marked starting with the deepest and using those as the reference for the rest of the tubular members.

Drilling

1. Position the drill rig over the location of the first 16.5 m.

2. Drilling to a depth of approximately 1 m, and continue rotating the drill and remove it from the bore hole, removing any loose soil with it. This soil should not be used for backfill and should be discarded in accordance with regulations.

3. Continue drilling until 18 m is reached, remove the drill and insert the 16.5 m tubular members.

4. Backfill using soil that was removed from the bore hole (not the soil that was taken from the first meter). Be sure to compact the backfill soil to prevent the hole from reopening.

5. Move the drill rig to the next location.

6. Repeat this drilling process with each of the various lengths of tubular members, always removing and discarding the first meter of soil no matter the depth of the hole drilled.

7. At the end of each day all bore holes should be closed, at no point should any hole be left open any longer than necessary.

8. All holes that have been drilled and back filled should also be checked periodically to ensure that none have reopened. If one has, backfill immediately.

### Test Results

A test of the effectiveness of the invention has been carried out in a sub region of a restricted contaminated area Chernobyl, Ukraine. That area is referred to as an exclusion zone, which covers about 2600 km². This area is contaminated due to a disaster caused by a complete melt down of Reactor 4 of the Nuclear Power Plant Apr. 26, 1986.

A government body, SSE Ecocenter is responsible for restricting entry to the zone and monitoring exclusion zone and compiling research data regarding the contaminated area. The General Director is Serhii Kirietev, a Ukrainian scientist.

The present inventor Andrew Niemczyk approached SSE Ecocenter and had confidential discussions for the possibility of testing his invention in a sub region within the exclusion zone. The concept of the present invention was discussed in some detail. These discussions resulted in an agreement in which Ecocenter in complete confidence would install the Niemczyk invention within the sub-region with the help and guidance of Mr. Niemczyk and Mr. Frank Mueller, an associate of Mr. Niemczyk.

The agreement between the parties, which did not involve any payments or other compensation given to SSE Ecocenter, between the inventor and SSE Ecocenter indicated that that project might be of particular interest and might eliminate the contamination much sooner than by natural decay.

This test comprised two sets of measurements taken within a sub region of the exclusion zone. The first set of measurements carried out on Oct. 15, 2019 and the second on Nov. 20, 2020.

The inventor asked SSE Ecocenter to make an initial series of measurements of radiation characteristics at 49 points within the sub region of the contaminated zone prior to the installation application of an array of elongated tubular members in the manner set forth in the present patent application.

In an effort to maintain a controlled experimental environment, all variables were kept the same (types of measurements, depths of measurements, location of measurements, measurement tools) and the radiation levels were measured.

At the request of the inventor Andrew Niemczyk, SSE Ecocenter prepared a report reflecting the initial set of measurements carried out by SSE Ecocenter in which the results of the first set are tabulated below, reflecting the results of the preliminary measurements in the sub region (having an area of 100 m²).

The tabulation has columns. Table 1 has 3 Columns. Column 1, labeled No. c.p., is simply the physical location of the marker in the exclusion zone. There were 49 total markers —indicating 49 separate, specific data point areas. Column 2, Flux Density is a measure of the amount of power or radiation that is transmitted through a specific area (and therefore not lost to the atmosphere). Column 3 uses the Sievert (Sv) which is the unit for the dose of radiation that affects the human body. The unit milliSievert (mSv) that we see more often is 1 thousandth, and microSievert (μSv) its 1 millionth. For the impact of radiation on human health, what counts is the total amount of radiation (cumulative dose) the body is exposed to. The intensity of radiation, “air dose.” is expressed with the amount of radiation dose per each hour while the body is at the location. We use microSievert per hour (μSv/h for hourly exposure and milliSievert per year (mSv/y) for annual exposure. Cumulative dose and air dose are related: e.g., when exposed to 1 μSv/h for 1 year, the total cumulative dose for the year is: 1 μSv/h×24 hours×365 days ˜9 mSv. To put into simple terms:

Column 1—point of measurement
Column 2—measure of power or energy through a set area
Column 3—measure of microSieverts per hour at said location on October 2019 prior to the installation of the array of tubular members
Column 4—measure of microSieverts per hour at said location on October 2020. 1 month after the completion of the array of tubular members

As is needed in any controlled experiments, the flux density values remained unchanged between the initial readings on Oct. 15, 2019 and latest readings on Oct. 29, 2020.

The important and only variable that changed was the radioactivity values set out in columns 3 and 4 indicating a dramatic decrease in contamination at each of the 49 individual test points.

As it takes approximately 5 month for the newly installed systems to be acclimated, it should be noted that the effect of the invention only began about five months after the installation of the tubular members, hence the measured results of the reduction in radioactivity would be substantially greater than shown in the measurements here if the reduction began at a later date.

| | Flux density. | EDRₘₐₓ₋ | |
|---|---|---|---|
| No. | βₘₐₓ | (μSv/h | |
| c.p. | part./(min cm²) | 2019/2020 | |
| 1 | 37 | 0.39 | 0.28 |
| 2 | 34 | 0.35 | 0.25 |
| 3 | 41 | 0.41 | 0.26 |
| 4 | 35 | 0.40 | 0.23 |
| 5 | 33 | 0.44 | 0.27 |
| 6 | 36 | 0.39 | 0.26 |
| 7 | 42 | 0.43 | 0.28 |
| 8 | 38 | 0.41 | 0.29 |
| 9 | 34 | 0.38 | 0.27 |
| 10 | 39 | 0.40 | 0.26 |
| 11 | 43 | 0.42 | 0.28 |
| 12 | 38 | 0.37 | 0.29 |
| 13 | 36 | 0.41 | 0.27 |
| 14 | 39 | 0.39 | 0.28 |
| 15 | 37 | 0.37 | 0.25 |
| 16 | 35 | 0.41 | 0.27 |
| 17 | 38 | 0.42 | 0.24 |
| 18 | 36 | 0.38 | 0.26 |
| 19 | 41 | 0.36 | 0.28 |
| 20 | 43 | 0.39 | 0.27 |
| 21 | 39 | 0.43 | 0.29 |
| 22 | 37 | 0.41 | 0.31 |
| 23 | 34 | 0.40 | 0.28 |
| 24 | 38 | 0.42 | 0.27 |
| 25 | 39 | 0.38 | 0.29 |
| 26 | 41 | 0.42 | 0.27 |
| 27 | 39 | 0.36 | 0.28 |
| 28 | 45 | 0.38 | 0.26 |
| 29 | 43 | 0.41 | 0.28 |
| 30 | 38 | 0.37 | 0.27 |
| 31 | 44 | 0.39 | 0.28 |
| 32 | 41 | 0.35 | 0.29 |
| 33 | 38 | 0.38 | 0.27 |
| 34 | 42 | 0.42 | 0.26 |
| 35 | 45 | 0.40 | 0.25 |
| 36 | 39 | 0.38 | 0.28 |
| 37 | 42 | 0.41 | 0.29 |
| 38 | 44 | 0.39 | 0.27 |
| 39 | 38 | 0.36 | 0.31 |
| 40 | 36 | 0.38 | 0.28 |
| 41 | 39 | 0.35 | 0.29 |
| 42 | 42 | 0.39 | 0.27 |
| 43 | 37 | 0.43 | 0.28 |
| 44 | 40 | 0.41 | 0.26 |
| 45 | 41 | 0.39 | 0.27 |
| 46 | 38 | 0.37 | 0.25 |
| 47 | 36 | 0.38 | 0.28 |
| 48 | 39 | 0.42 | 0.27 |
| 49 | 37 | 0.39 | 0.28 |

1. A method of increasing the rate of decontamination of soil containing radioisotopes from the natural rate of decontamination, including drilling an array of vertical holes downward through the surface of the ground in a region of the ground which is contaminated;
installing a respective elongated tubular member in each hole of an array of vertically extending drilled holes; forming said elongated tubular member formed with a cluster of parallel passageways extending along the length of said elongated tubular member main portion;
each of said elongated tubular member having a slot extending radially into each passageway along the length of said elongated member so as to allow entry of positrons emitted from radioisotopes and passing through the soil, said positrons redirected vertically upward within each of said passages; and
installing a cap on an upper end of each of said tubular elongated members blocking said slots on said end thereof and said passages of the upper end of each elongated member main portion to cause said flow of said positrons to be reversed and to be directed down into the continuing upward flow of said positrons to cause flow of said positrons to radially out into said soil and in an upward direction in said soil to cause contact of said positrons with unstable nucleuses of atoms of radioisotopes therein thereby said contact causing stabilization of said nucleuses so as to substantially increase the rate of decontamination to be much greater than by natural decay processes.

2. The method according to claim 1 wherein sets of said elongated tubular members are established which are of differing lengths with longer elongated members disposed deeper in the soil and with an upper end further below the ground surface, said longer members being fewer in number than said shorter members.

3. The method according to claim 1 wherein six sets of differently configured and installed elongated members are installed in said drilled holes with characteristics as follows:
10A. Length 16.5 m
Drill Depth: 18.0 m
Depth of Top Below Surface: 1.5 m
Number of Holes: 9
10B. Length 14 m
Drill Depth: 14.9 m
Depth of Top Below Surface: 0.9 m
Number of Holes: 16
10C. Length 11.2 m
Drill Depth: 11.8 m
Depth of Top Below Surface: 0.6 m
Number of Holes: 56
10D. Length 8.4 m
Drill Depth: 11.8 m
Depth of Top Below Surface: 0.4 m
Number of Holes: 208
10E. Length 5.6 m
Drill Depth: 5.8 m
Depth of Top Below Surface: 0.2 m
Number of Holes: 800
10F. Length 2.8 m
Drill Depth: 3.0 m
Depth of Top Below Surface 0.2 m
Number of Holes and elongated tubular members installed therein: 3,136
10G. Length 0.45 m
Drill Depth: 0.53 m
Depth of Top Below Surface 0.07 m
Number of Holes: 624

4. The method according to claim 3 wherein each of said elongated tubular members are uniformly spaced apart a distance of 1.6 meters in both X and Y directions defining said planar array.

5. An elongated tubular member in combination with a cap fit over an upper end of said elongated tubular member arranged to collect and direct a flow of positrons into a soil region below said ground surface to a predetermined depth and a short distance above said ground level, said elongated tubular member having a cluster of lengthwise extending passageways arrayed around a center of said cluster of said passageways, each passageway having an associated circular wall portion and having a radially extending through slot in a radially outermost part of each of said wall portions;
a cap fit over an upper end of said elongated tubular member extending down from said upper end, said cap having a continuous circular wall fit over said cluster of passageways so as to block said slots therein, said cap having a closed upper end such that positrons flow up said elongated tubular member are constrained by said cap closed upper end to be reversed and directed back downwardly and meeting upward flow of said positrons causing radially outward and upward positron flows from a bottom end of said cap.

6. The combination according to claim 5 wherein said elongated tubular member has five outer passageways, arranged in a circle around said center of said passageway cluster.

7. The combination of claim 6 wherein an inner passageway is defined within said five passageways which comprise outer passages and said inner passageway defined by inner walls defining said five outer passageways, with a slot through one of said walls extending from said inner passageway and aligned with a slot associated with one of said five outer passageways to allow entry of said positrons flow into said inner passageway through said inner passageway slot.

8. The combination according to claim 5 wherein said cap has a series of cavities extending along a length of said cap arranged outside said portion defining said circular wall, a slot extending into a wall defining each of said cavities, said slot extending along the length of said cap.

9. The combination according to claim 5 wherein said cap is about seven inches long.
